(19) United States
(12) Patent Application Publication
(10) Pub. No.: US 2023/0001992 A1
(43) Pub. Date: Jan. 5, 2023

(54) INTEGRATED HITCH MOUNTING SYSTEM

(71) Applicant: HORIZON GLOBAL AMERICAS INC., Plymouth, MI (US)

(72) Inventors: Henry J. Guthard, Livonia, MI (US); Matthew Dunlavey, Ann Arbor, MI (US); Mark Scruggs, Walled Lake, MI (US); Kevin Garner, Swartz Creek, MI (US); Jacob Vaillancourt, Plymouth, MI (US)

(21) Appl. No.: 17/779,216

(22) PCT Filed: Nov. 25, 2020
(86) PCT No.: PCT/US2020/062217

§ 371 Date: May 24, 2022

Related U.S. Application Data
(60) Provisional application No. 62/940,083, filed on Nov. 25, 2019.

(51) Int. Cl. B62D 53/08; B60R 9/06; B62D 33/02

(52) U.S. Cl. CPC B62D 53/08; B60R 9/06; B62D 33/02

(57) ABSTRACT

A hitch mounting system integrated into to a vehicle, where the vehicle includes a frame and a body, including a load bed having an integrated mounting apparatus. The hitch mount system includes a receiving member, which may be a receiving member that is integrated with the frame of a vehicle capable of attaching to a fifth wheel or a gooseneck trailer attachment through the body or bed of the vehicle.

### CROSS REFERENCE TO RELATED APPLICATIONS

This application claims priority to Provisional Patent Application No. 62/940,083 filed on Nov. 25, 2019 and entitled “Integrated Hitch Mounting System,” which is incorporated herein by reference.

### TECHNICAL FIELD

The present disclosure relates generally to a towing apparatus and, more particularly, to a hitch mounting system integrated into the frame of a vehicle, such as a truck, and accessed through the body, such as the bed, of the vehicle.

### BACKGROUND

Many vehicles are designed to transport freight, goods, merchandise, personal property, and other such cargo. An operator often utilizes a hitch assembly to connect a towed vehicle to a towing vehicle, e.g., connecting a trailer to a pick-up truck, to increase the capacity to transport the cargo. Other types of cargo carrying accessories may also be mounted or attached to a vehicle as well to assist with carrying various items such as bicycles, motorcycles, lawn equipment, ATVs, ladder holders, construction equipment and accessories, slide out beds and the like. Many types of coupling devices have been developed for providing this connection between the towing vehicle and towed vehicles or cargo carrying accessories.

When towing a trailer or camper, for example, it is well known to utilize a hitch to connect the towed vehicle to a towing vehicle. There are many different types of hitches that may be attached to the towing vehicle in a variety of ways, depending on the type of hitch used. For example, some fifth wheel hitches mount to the frame underneath the bed of the pickup truck while other fifth wheel hitches mount to an above bed mounting system.

Traditional fifth wheel hitches include a head assembly for receiving a king pin on a towed vehicle, a base having a plurality of legs, and one or more mounting rails. In some systems, the legs of the fifth wheel hitch are designed to be secured to mounting rails that are attached above or on the load bed of the towing vehicle. In other systems, the mounting rails may be fixed to the frame of a vehicle underneath the bed. For example, the mounting rails may be connected between two portions of a pickup truck frame underneath the truck bed. The mounting rails may include a plurality of apertures for receiving the legs of the fifth wheel hitch.

Corresponding openings may be cut in the truck bed and aligned with the apertures in the mounting rails. The legs of the fifth wheel hitch may be connected to apertures in the mounting rails through the openings in the truck bed, thereby securing the fifth wheel hitch to the frame of the vehicle. When the fifth wheel hitch is not in use, the legs may be disconnected from the apertures in the rails and the hitch may be removed from the bed of the truck. Caps may be placed over the apertures to allow the truck bed to be used for other purposes.

Traditional gooseneck hitches may also mount to a towing vehicle frame beneath the load bed of the towing vehicle. A gooseneck hitch may be designed for use in a load bed of a towing vehicle similar to a fifth wheel hitch. The difference is that the gooseneck uses a ball and coupler verses a kingpin and pin receiver. Gooseneck hitches may include a mounting plate configured to connect to the frame of the towing vehicle, a receptacle in the mounting plate configured to receive a hitch ball, and the hitch ball may be removably connected to the receptacle and configured to engage a coupling member of the towed vehicle. An opening in the load bed of the towing vehicle may be aligned with the receptacle in the mounting plate. This may allow the hitch ball to connect to the receptacle through the opening in the load bed of the towing vehicle. The hitch balls themselves are typically removable or retractable when not in use. This may generally prevent obstruction of the load bed of the towing vehicle.

Towing vehicles are generally arranged to accommodate either a fifth wheel hitch or a gooseneck hitch, but not both. To convert a towing vehicle from accommodating a fifth wheel hitch to a gooseneck hitch or vice versa is time and labor intensive and inefficient. However, since fifth wheel hitches and gooseneck hitches use different mounting configurations, traditionally only one hitch can occupy this location. Therefore, there is a need in the art for an improved apparatus for towing vehicles that may allow for selectively accommodating either a fifth wheel hitch or a gooseneck hitch.

Additionally, because the mounting rails attach to the underside of the towing vehicle, there may be significant space limitations. This may impact the ability to attach mounting rails to the underside of the towing vehicle, including, without limitation to the frame of the towing vehicle. Therefore, there is a need in the art for improved mounting systems that are integrated with a towing vehicle frame.

### SUMMARY

Disclosed is a hitch mounting system capable of attaching to a vehicle, where the vehicle includes a frame and a body wherein the body has, for example, a load bed having an integrated mounting apparatus. The hitch mounting system may include at least one rail and a receiving member integrated with an under body/bed portion of a load bed of a vehicle capable of attaching to a fifth wheel attachment, a gooseneck trailer attachment or other cargo carrying accessories such as accessories for carrying bicycles, motorcycles, lawn equipment, ATVs, ladder holders, construction equipment and accessories, slide out beds and the like. In one embodiment, the frame may include an inserted feature such as a casting or other manufactured part, weldments, or other combination of parts into a vertical aperture/hole in the frame of the vehicle. The parts may either be welded to the frame or attached via fasteners such as nuts along the top and or bottom or the parts may be incorporated by a threaded mechanism. The frame may include a receiving member having a receiving member pattern in order to receive an attachment member in a receiving member attachment pattern. The receiving member pattern and receiving member attachment pattern may be generally complementary shaped. The receiving member pattern may be in a football-type shape or any other shape to accommodate engagement with the receiving member attachment. The inserted feature may further be adjustable along the height in order to maintain a planar surface during installation. In another embodiment the inserted feature may be flush or below the ridges of a corrugation in a truck bed and align with apertures/holes in the bed of the vehicle.

Throughout this disclosure, the terms aperture and hole may be used interchangeably as well as the terms body and bed, without intending to affect the scope of the disclosure.

The under bed integrated frame hitch mounting system disclosed more specifically relates to the integration of a mounting system into or onto the frame of a vehicle for attaching a fifth wheel attachment, a goose neck towing mechanism or other cargo carrying accessory directly to the frame of the vehicle eliminating the need for external attachments of under bed mounting systems to a frame in order to integrate a towing apparatus such as a fifth wheel, goose neck or other cargo carrying accessory. More specifically, this disclosure relates to the use of one or more receiving members pucks integrated into or onto the frame of the vehicle.

In another embodiment, the frame may include at least one flange to receive a receiving member. The flange may be in any shape to accommodate various receiving members and may further include a slot that may be shaped to accommodate various designs. The flange may be configured to accommodate the use of a t-pin style system having a larger t-bushing. In this embodiment, installation of a fifth wheel or gooseneck hitch is all integrated in the truck bed and does not require the use of pin attachments from underneath the bed. In another embodiment, the system may accommodate overlap joints for attachment of an additional bolt-on under bed system for the use of heavy-duty trucks.

In another embodiment, the integrated design utilizes inserts having various lengths integrated into a frame for configuration with a threaded receiving member. In an embodiment, a threaded tube may be inserted into the frame. Various insert lengths may be utilized for adjustment to various hitch configurations. The threaded tube may be affixed to the frame via various methods including welding or fastening such as with bolts or rivets. A threaded receiving member may then be inserted into the threaded tube, the threaded receiving member having an adjustable height and further including an additional spacer for adjustment to the particular hitch member configuration. An alignment pin and spanner wrench may be used to attach and secure the system. The spanner wrench may be configured for use with a hex head shape threaded insert or any other shape presented within the system. The design may further include a trim panel made of plastic or any other satisfactory material shaped over the bed corrugation for aiding alignment of the receiving member. The trim panel may embody a hex head shape threaded insert and bed corrugation to further secure the system. An anti-corrosion coating or material may be disposed to prevent corrosion along any surfaces of the frame or among receiving member attachment components.

In one embodiment, the invention includes a vehicle comprising a frame and a body, and further comprising a hitch or cargo carrying mounting system that is integrated into or onto the frame of the vehicle and is accessible through at least one aperture in the body of the vehicle.

In a further embodiment, the frame of the vehicle has at least one frame aperture for receiving a hitch or cargo carrying attachment and the body of the vehicle has at least one body aperture which matches up with the frame aperture.

In a further embodiment, in the vehicle, the hitch mounting system comprises at least one mounting structure that is attached to the frame of the vehicle, and the body of the vehicle has at least one body aperture which matches up with the mounting structure attached to the frame.

In a further embodiment, in the vehicle there are at least five frame apertures and five corresponding body apertures.

In a further embodiment, in the vehicle, there are at least 4 mounting structures attached to the frame of the vehicle and 4 corresponding body apertures.

In a further embodiment, the vehicle further comprises at least one aperture in the frame of the vehicle which matches up with at least one aperture in the body of the vehicle.

In a further embodiment, in the vehicle, the frame aperture has at least one insert inside the aperture which is configured to receive a trailer hitch mechanism.

In a further embodiment, the vehicle comprises a hitch mounting system which comprises a receiving member attachment that is inserted in one or more of the apertures in the frame of the vehicle and passes through one or more of the corresponding holes in the body of the vehicle.

In a further embodiment, the vehicle comprises a receiving member attachment which is configured to receive a fifth wheel-type trailer hitch.

In a further embodiment, the vehicle has a frame aperture which has at least one insert that is incorporated inside the frame aperture wherein the insert is configured to receive a trailer hitch mechanism or cargo carrying attachment mechanism.

In a further embodiment, the insert in the frame is a threaded sleeve.

In a further embodiment the mounting structure on the frame of the vehicle has at least one mounting structure aperture.

In a further embodiment, the mounting structure aperture has at least one insert incorporated inside the aperture wherein the insert has an insert aperture which is configured to receive a trailer hitch mechanism.

In a further embodiment, the mounting structure has an insert which comprises a threaded sleeve and wherein the body aperture in the vehicle matches up with the threaded sleeve in the mounting structure.

In a further embodiment, the mounting structure is attached to the frame by bolts, welds or a combination thereof.

In a further embodiment, the bolts in a mounting structure go through the frame or are part of a clamp or bracket device that attaches around at least part of the frame.

In a further embodiment, the mounting structure further comprises a receiving member inserted into a mounting structure aperture.

In a further embodiment, the mounting structure has an insert and the insert further comprising a receiving member inserted into an insert aperture.

In a further embodiment, the insert in either the frame or the mounting structure has an internal insert aperture that extends entirely through the insert and the frame aperture extends entirely through the frame.

In a further embodiment, the insert in the mounting structure has an insert aperture that extends entirely through the insert and the mounting structure aperture extends entirely through the frame.

In a further embodiment, the invention comprises a mounting system for attaching a hitch mounting system or cargo carrying accessory to a frame of a vehicle having a body and a frame, the mounting system comprising at least one mounting structure that is capable of being attached to the frame of the vehicle, wherein the body of the vehicle has at least one body aperture which matches up with the mounting structure when attached to the frame.

In a further embodiment, the mounting structure of the mounting system has at least one mounting structure aperture.

In a further embodiment, the mounting structure aperture has at least one insert incorporated inside the aperture wherein the insert has an insert aperture that is configured to receive a hitch mounting system or cargo carrying accessory.

In a further embodiment, the insert in the mounting structure comprises a threaded sleeve and wherein the body aperture matches up with the threaded sleeve.

In a further embodiment, the mounting structure is attached to the frame of the vehicle by bolts, welds or a combination thereof.

In a further embodiment, the mounting structure is attached by bolts and the bolts go through the frame or are part of a clamp or bracket device that attaches around at least part of the frame.

In a further embodiment, the insert in the mounting structure has an insert aperture that extends entirely through the insert and the mounting structure aperture extends entirely through the mounting structure.

In a further embodiment, the mounting system has a mounting system aperture which further comprises a receiving member incorporated into the mounting system aperture.

In a further embodiment, the mounting system comprises an insert having an insert aperture, further comprising a receiving member incorporated into the insert aperture.

### BRIEF DESCRIPTION OF THE DRAWINGS

The present teachings may be better understood by reference to the following detailed description taken in connection with the following illustrations, wherein:

FIG. 1 is a perspective view of the hitch mounting system;

FIG. 2 is a top perspective view of the hitch mounting system of FIG. 1;

FIG. 3 is a bottom perspective view of the hitch mounting system of FIG. 1;

FIG. 4 is a perspective view of a threaded tube attached to a frame and a threaded receiving member attached thereto;

FIG. 5 is a perspective view of a frame including a threaded tube for receiving a receiving member;

FIG. 6 is a perspective view of a frame including a threaded tube for receiving a receiving member;

FIG. 7 is a perspective view of an anchor system for securing a receiving member to a frame;

FIG. 8 is a perspective view of an anchor system for securing a receiving member to a frame;

FIG. 9 is a cut away view of an anchor system for securing a receiving member to a frame;

FIG. 10 is a top perspective view of a receiving member integrated into a frame;

FIG. 11 is a perspective view of a receiving member integrated into a frame;

FIG. 12 is a bottom perspective view of a receiving member integrated into a frame;

FIG. 13 is a perspective view of a receiving member aperture created in a frame;

FIG. 14 is a perspective view of a receiving member integrated into a frame;

FIG. 15 is a perspective view and cut away view of a receiving member attached to a frame;

FIG. 16 is a perspective view of a receiving member interface attached to a frame;

FIG. 17 is a perspective view of a receiving member attached to a frame;

FIG. 18 is a perspective view of a receiving member integrated into a frame;

FIG. 19 is a perspective view of a receiving member integrated into a frame;

FIG. 20 is a perspective view of a portion of an ISR using the integrated mounting system;

FIG. 21 is an exploded view of a portion of an ISR using the integrated mounting system;

FIG. 22 is an exploded view of a frame with a plug and a section view of the frame without the plug;

FIG. 23 is a sectional view of a frame with a plug inserted;

FIG. 24 is a sectional view of a frame with apertures created from folding portions of the frame;

FIG. 25 is a perspective view of bed of a vehicle having an integrated ball hitch system;

FIG. 26 is a perspective view of a bed of a vehicle having a fifth wheel hitch attached to an integrated hitch system.

### DETAILED DESCRIPTION

Reference will now be made in detail to exemplary embodiments of the present disclosure, examples of which are illustrated in the accompanying drawings. It is to be understood that other embodiments may be utilized and structural and functional changes may be made without departing from the respective scope of the present disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

Further, the same reference number may be used to describe similar components within the disclosure. It should be understood, however, that these components may have different configurations, the same configuration or substantially similar configurations. Further, these components may be utilized in different manners in the various embodiments.

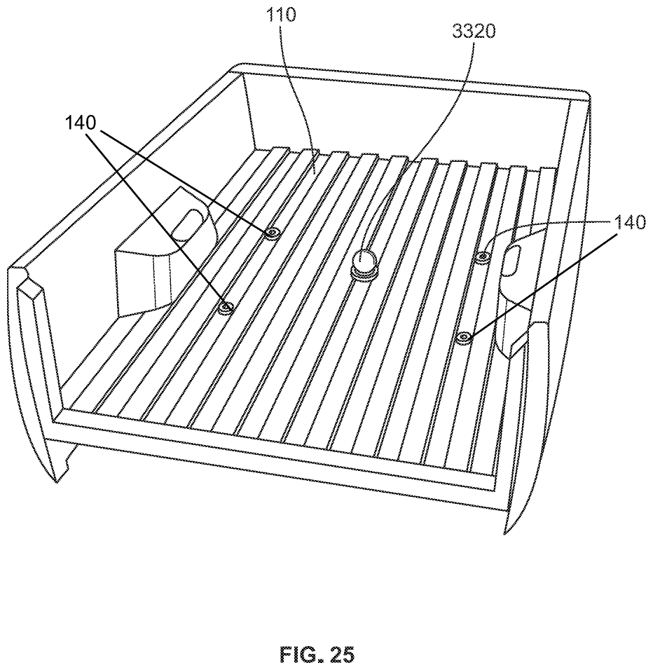

Disclosed is an exemplary hitch mounting system 100 capable of attaching to an under bed/body portion of a vehicle. The vehicle may include a frame 120 and a body, such as a truck load bed 110 (see FIG. 25 for example) that may be positioned above or on adjacent (such as next to or parallel) to the frame 120. The vehicle may include an integrated hitch mounting system 100 configured to attach various accessories to the vehicle, including, without limitation trailer attachments, such as a fifth wheel hitch, a gooseneck hitch with safety chain tie down members, accessories, including, without limitation a sliding bed, a bike rack, a motorcycle rack system, kayak holder, canoe holder, ski rack, surf board rack, snowboard rack, ladder holder, light holder, grill holding device or the like. The present system may be utilized with any kind of accessory and is not limited to just that shown and described herein.

Typical mounting systems utilize a rail members or H frame to attach a trailer to the vehicle frame. The hitch mounting system 100 of the current disclosure does not require the use of a separate rail members and may be integrated with the vehicle frame 120 itself by incorporation of hitch receiving members 140 or pucks into the frame 120 itself or onto the frame 120. Discussed below are various embodiments of how a receiving member 140 or receiving members may be attached, such as directly attached, to the frame 120 or structural member of a vehicle.

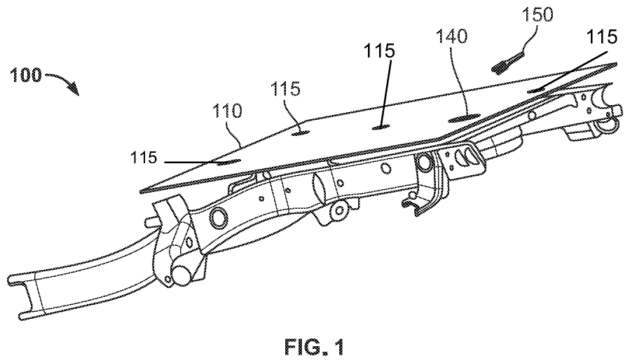

As shown in FIGS. 1-3, for example, the hitch mounting system 100 may include at least one receiving member 140, which may be called a puck that is integrated or directly or indirectly attached with a frame 120 or structural member of a vehicle under the load bed 110. The receiving member 140 is capable of having attached thereto an accessory and/or a towing attachment system, such as a fifth wheel or a gooseneck trailer attachment or other cargo carrying attachments. Integration of the hitch mounting system 100 provides for load sharing between the top and bottom member of the truck frame, and provides improved drainage through the frame 120, which further lowers the amount of debris buildup inside the hitch mounting system 100. In the embodiments disclosed, frame apertures 125 (and inserts 155 if present, such inserts 155 may include insert apertures) in the frame 120, as well as mounting structures 910 with apertures 125. The foregoing may align with and are accessible through body apertures 115 in the body 110 (or load bed) of the vehicle. In all cases hereinafter, reference to an insert 155 includes an insert with an insert aperture internally for insertion of a receiving member 140 or a hitch or cargo carrying apparatus or a fastening device, such as disclosed in U.S. Pat. No. 9,522,583, which is incorporated herein by reference.

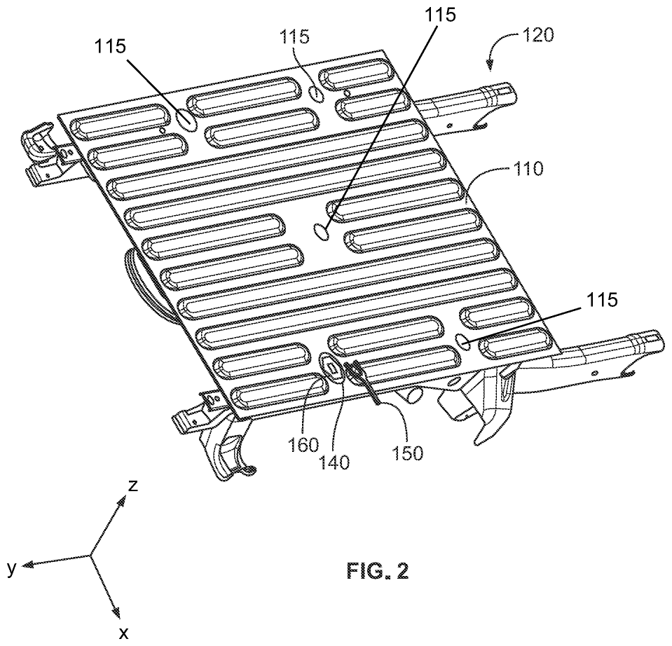

As shown in FIGS. 1-3, the hitch mounting system 100 may include receiving members 140 (such as the four shown in FIG. 1) of any appropriate configuration, including, without limitation, U.S. Pat. No. 8,414,009, which is incorporate herein by reference. The hitch mounting system 100 may be attached to the frame 120 in any appropriate manner, including, without limitation, via welding, fastening or the like. The receiving members 140 may be positioned in body apertures 115 that are positioned in the load bed 110 of the vehicle. There may be any appropriate number of body apertures 115 in the load bed 110, including, without limitation, one, two, three, four, five, six, seven, eight or more. The hitch mounting system 100 may include an equivalent number of receiving members 140 as body apertures 115. The body apertures 115/receiving members 140 may be of any appropriate configuration on the load bed 110. For example, the receiving member's 140/body apertures 115 may be in a square, rectangular, trapezoidal, circular, oval or the like shape. For example, as shown in FIG. 2, there may be four the receiving members 140/body apertures 115 in a generally rectangular shape along with a fifth one in the center.

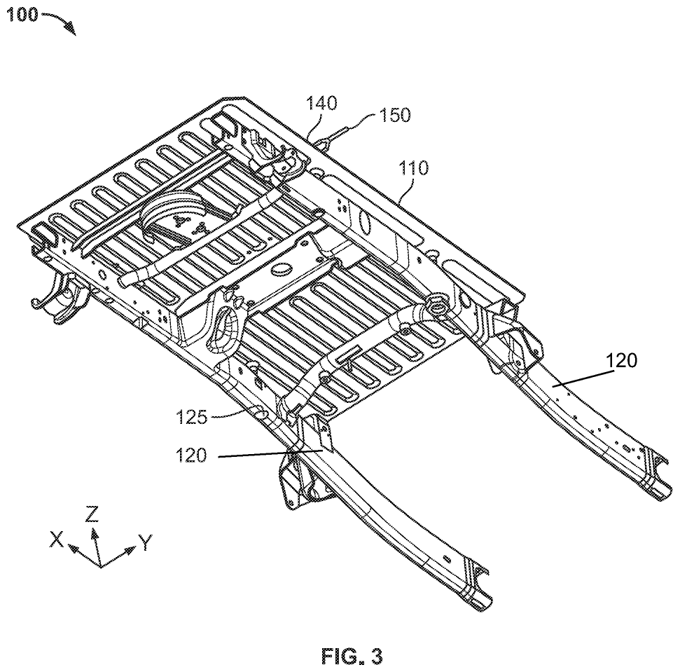

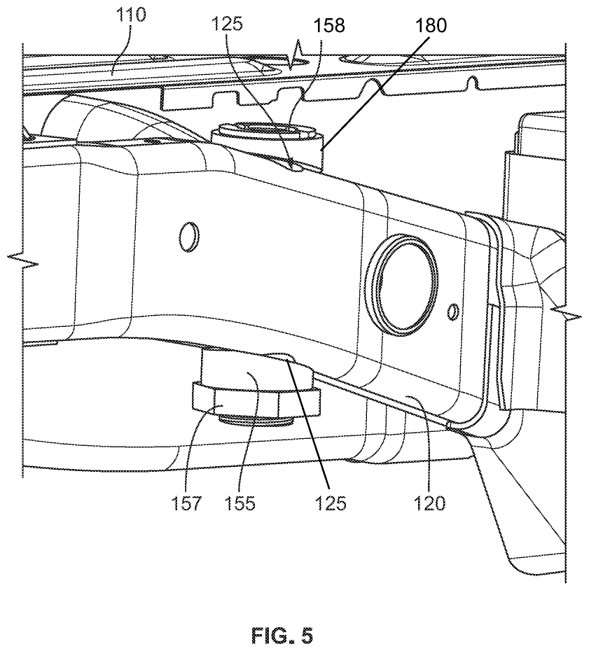

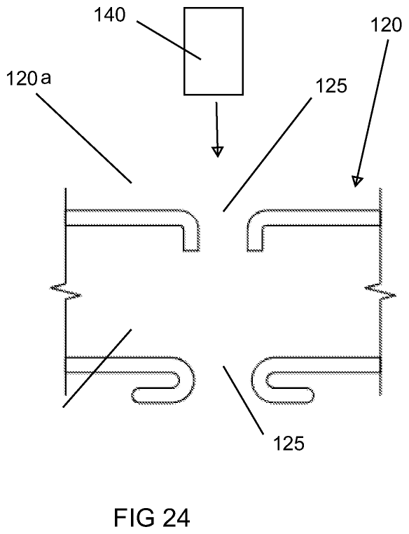

In one embodiment as shown in FIG. 5, the frame 120 may include an insert 155 having an insert aperture, such as a casting or other manufactured part, weldments, or other combination of parts inserted into a vertical aperture/hole 125 in the frame 120. In one embodiment, the vertical aperture/hole 125 may be at least on the side of the frame 120 (or both sides of the frame) that is adjacent to the underside of the body/load bed 110 (the “top” of the frame). In another embodiment, the vertical aperture/hole 125 may extend through the lower side of the frame (or “bottom” of the frame). Having an aperture/hole 125 in the bottom of the frame 120, as shown in FIG. 3 for example, provides an access point for cleaning/draining of debris or liquid (water) as well as an access port for assisting with receiving member 140 installation or accessory connection. The components may either be welded via welds 159 (as shown for example in FIG. 23a) to the frame 120 or attached via fasteners such as nuts 157 along the top and/or bottom (as shown for example in FIG.). In such embodiments, a tube member 180 may be inserted into the frame aperture 125. In these embodiments, there may be four frame apertures 125 and four tube members 180. Although, the present disclosure may contemplate one, two, three, five, six or more such frame apertures 125 and tube members 180. The frame apertures 125 may generally align with the body apertures 115 and may comprise the same number of such. The hitch mounting system 100 in FIG. 5 may include a spacer 158, which help align the hitch mounting system 100 or more specifically the receiving member 140 to be operatively positioned relative to the load bed 110, e.g., the receiving member 140 may be generally aligned with the load bed 110. The tube member 180 may be configured to operatively receive the receiving member 140 in any appropriate manner, such as being threaded, welded, fastened or the like. The nut 157 may be attached, such as being threaded to the tube member 180 to lock the tube member 180 to the frame 120 in an operative position. While the nut 157 is shown as being threaded, it can also be welded, fastened, adhered or the like.

The receiving members 140 may further include a receiving member pattern in order to receive a receiving member attachment wherein the receiving member pattern is generally complementarily shaped relative to the receiving member attachment shape. The receiving member pattern may be in a football-type shape, a slot, rectangular shape, square shape, oval shape or any other shape to accommodate a receiving member attachment, such as a T-pin device that is selectively locked to the receiving members 140. The inserted feature may further be adjustable along the height in order to maintain a planar surface during installation. Further, the hitch mounting system 100 and all of the components therein may include anti-corrosion materials or coatings along the edges to further protect the frame 120 and other components from corrosion.

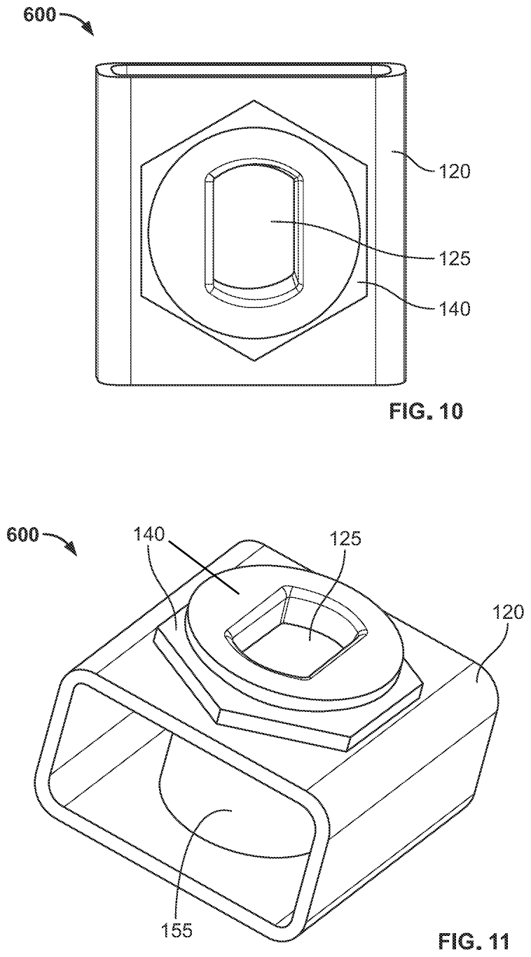

The hitch mounting system 100 may be utilized for attaching an accessory such as a fifth wheel hitch assembly, goose neck hitch or other cargo carrying accessory directly to the frame 120, eliminating the need for external attachments of under bed mounting systems to the frame 120. More specifically, this disclosure relates to the use of a receiving member 140 or receiving members integrated into the frame 120. FIGS. 10-19 illustrate various embodiments of receiving members 140 that are integrated with various shaped frames 120.

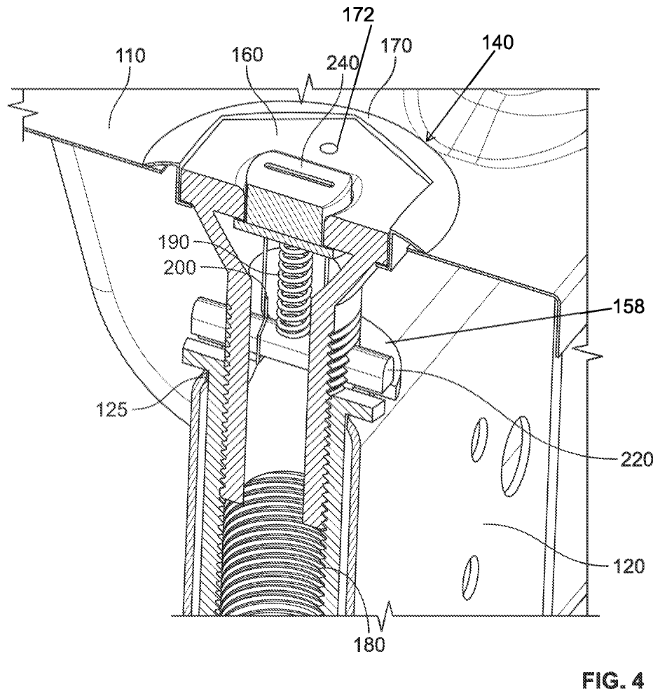

In another embodiment as illustrated by FIGS. 4-6, the integrated design utilizes inserts 155 having insert apertures and which have various lengths integrated into a frame 120 via a threaded receiving member 140. In an embodiment, a threaded tube or insert 180 may be inserted into the frame 120. And insert 155, which may also comprise a threaded tube 180, may be affixed to the frame 120 via various methods including welding, threading or fastening such as with bolts, nuts 157, or rivets or the insert 155, or threaded tube 180, may have external threads as well and may be incorporated into the frame 120 via aperture 125 utilizing a threaded mechanism. A threaded receiving member 140 may then be inserted into the threaded tube 180, the threaded insert or receiving member 140 may allow the height of the receiving member to be adjusted relative to the load bed 110. This may allow the receiving member 140 to be positioned at an operative height in any vehicle. In other words, the user need only thread the threaded tube 180 and/or the receiving member 140 to the appropriate height so that the receiving member is at generally the same height as the load bed 110. Further, an additional spacer 158 may be included to further adjust the height of the receiving member 140 to be at an operative height relative to the load bed 110. The spacer 158 allows for height adjustment of the receiving member 140 to account for variations in distance between the frame 120 and the body 110 of the vehicle as well as allowing for the receiving member 140 and inserts 155 to be used in different vehicles (the same holds true for the threads on the threaded tube 180 and/or receiving member 140). The spacer 158 further ensures that the receiving member 140 is adjustable to become flush with the body 110 of the vehicle.

In a further embodiment, a receiving member plug 240, as shown in FIG. 4, may be incorporated into a threaded-in receiving member insert system 140 via any means of connection including welding or bolts in the sleeve. In one embodiment as depicted in FIG. 4, the plug 240 stays in the threaded receiving member 140 and eliminates the need to remove a removable plug and risk the possibility of losing it. The receiving member plug 240 further helps with a locking rod 220 to prevent rotation of the threaded receiving member 140 once installed in the integrated frame system. A biasing member (such as spring 190) and/or a locking rod 220 can be dimensioned to eliminate the need for a “T-pin” insert unless a locking rod 220 is in place. If needed, the locking rod 220 can be lifted using a cable 200 from above or from below with a notched pipe (not shown). The notch in the pipe allows for unlocking and rotation from under the frame 120 (this is the backup removal plan in the event a preferred mode of removal is not an option). The preferred install/removal mechanism would include use of the cable 200 and a spanner wrench 150 from the bed side. The locking rod 220 may prevent the receiving member 140 from being threaded away from or into the threaded tube 180, i.e., it prevents the threads on the receiving member 140 from rotating relative to the threaded tube 180 keeping the receiving member 140 in its position.

In a further embodiment, an alignment pin 172 and spanner wrench 150 may be used to attach the hitch mounting system 100 or more specifically to help thread the receiving member 140 with the threaded tube 180. The spanner wrench 150 may be configured for use with a shaped head of the receiving member 140, such as a hex shape head 160 for the threaded receiving member insert 140 as well as any other type of receiving member 140, or any other shape insert presented within the hitch mounting system 100. The alignment pin 172 may allow the receiving member 140 to be aligned in an operative position relative to the insert 155. The insert 155 may include an aperture and the receiving member 140 may include an aperture. When the apertures are aligned, the alignment pin 172 may be inserted into the apertures ensuring the receiving member 140 is operatively aligned and operatively aligned relative to the insert 155. The alignment pin 172 may further prevent the receiving member 140 from rotating relative to the threaded tube 180 to which it is threaded fixing the receiving member 140 in its operative position, which may also prevent removal of the receiving member 140.

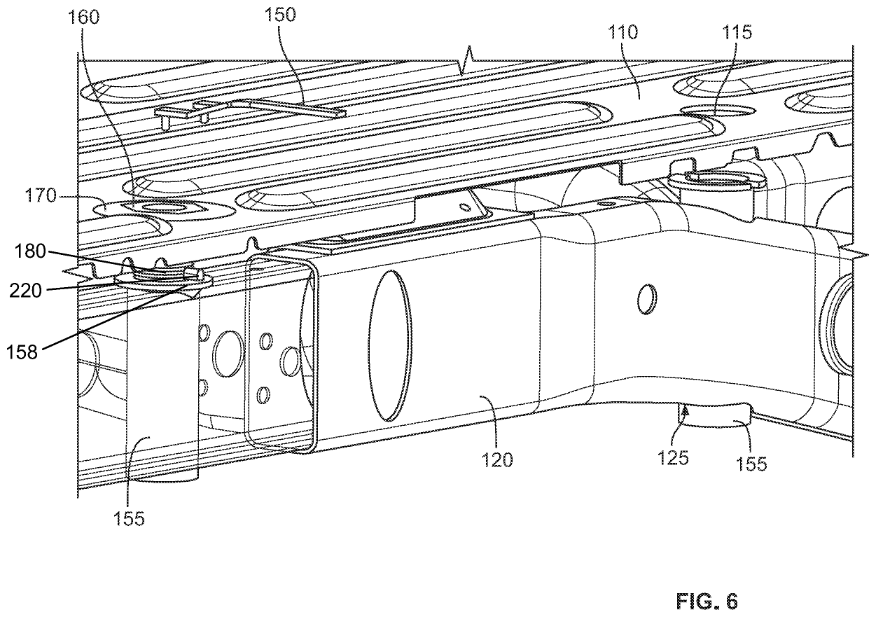

The hitch mounting system 100 may further include a trim panel 170 made of plastic or any other satisfactory, resilient material shaped over the bed corrugation to create a finished look to the bed of the truck when the hitch mounting system 100 is installed. As shown in FIGS. 4 and 6, the trim panel 170 may include an opening the operatively accommodates the hex head 160 shape threaded receiving member 140 and bed corrugation to further secure the hitch mounting system 100 and create the finished look to generally match the corrugation of the bed of the towing vehicle.

In another embodiment, as shown in FIG. 4, a locking bar 220 or any other member may be inserted through the frame 120 at a height configured to accommodate the accessory attachment member, as illustrated in FIG. 4. In this embodiment, the portion of the frame 120 including the bar or other member insertion may further include a receiving member slot hole shape or another shape of a receiving member cut into it. The bar or member may be secured by either a fastener (not shown), via welding or any other configuration of attachment. The integrated frame receiving member or receiving member feature may be shaped using methods including hydro-forming and may further function as the top of the receiving member and bear all the loads except the vertical up load, which may be supported by a “T” pin or other equivalent apparatus. The formed receiving member may also be integrated with other frame stiffening processes described herein to provide vertical strength in lieu or conjunction with a “T” pin or other equivalent apparatus.

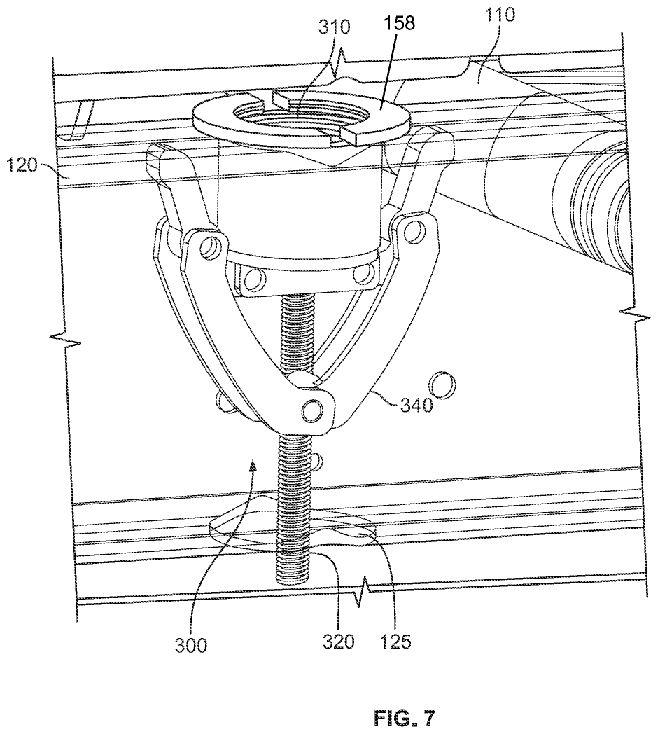

In another embodiment, as illustrated in FIGS. 7, 8, 9, the hitch mounting system 100/under bed anchor system 300 may further use a threaded insert 310 having a plunger/anchor style or rivet to further secure the receiving member 140 to the frame 120. The under bed anchor system 300 of this embodiment utilizes a lever and ramp configuration to secure a receiving member 140 or other attachment in a threaded insert 310 of a frame 120. Lever arms 340 and a threaded bolt 320 may be used to clamp the “receiving member accepting sleeve” into place in the frame 120, shown in FIGS. 7-9 as, for example, the under bed anchor system 300. An aperture 125 in the bottom and top of the frame 120 may allow for extension of threaded bolt 320 as well as lever arms 340 when moving from an engaged to disengaged clamping position relative to the truck bed 110. The spacer 158 allows for further height adjustment to ensure the threaded insert 310 is flush with the body 110 of the vehicle.

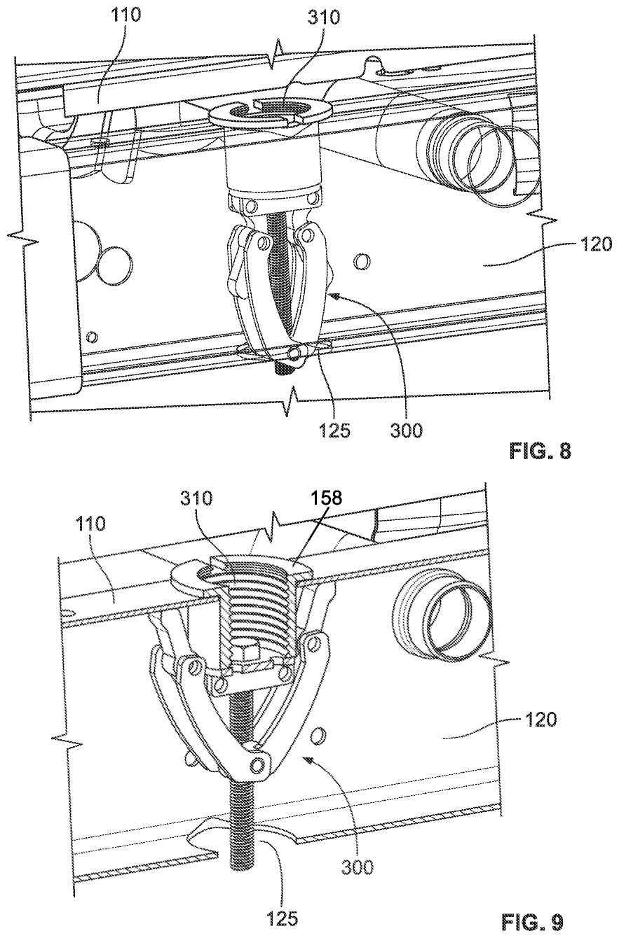

In this embodiment, the threaded insert 310 may be inserted into the frame aperture 125. The lever arms 340 may pivot to allow the threaded insert 310 to be inserted into the frame aperture 125—see FIG. 8. Once inserted, the lever arms 340 will rotate relative to the body of the threaded insert 310 to an engaged position such as that shown in FIG. 9. In this position, the lever arms 340 will engage an underside of the load bed 110. This engagement will prevent withdrawal of the threaded insert 310 from the frame aperture 125 and locks the threaded insert relative to the frame 120. To rotate the lever arms 340, a user may rotate or screw the threaded bolt 320, which will position the lever arms 340 from the disengaged position (FIG. 8) to the engaged position (FIG. 9).

In other embodiments, as shown in FIGS. 10-12, 14, 16, 18, 19, 22 and 23 a receiving member 140 or insert 155 may be affixed to the top of the frame 120 via any suitable means of fastening including, but not limited, to a bolt configuration, rivets, and welding or being integrally or monolithically formed therewith. In each of these embodiments, the shape of the aperture 125 in the receiving member 140 can be any shape that is configured and suitable for receiving an accessory, including, without limitation, a sliding bed, a bike rack, a motorcycle rack system, a fifth wheel hitch, safety chain tie downs, a gooseneck hitch and the like. For example, the aperture 125 may be shaped to receive a T-pin engagement device, such as shown in U.S. Pat. No. 7,121,573, which is incorporated herein by reference. In addition, the receiving member 140 may be incorporated into the top side of frame 120 or may be incorporated into an insert 155 that extends through the frame 120, such as being formed therewith or attached through a subsequent operation. There may be an aperture 125 in the bottom of the frame 120 whether or not insert 155 is present or not.

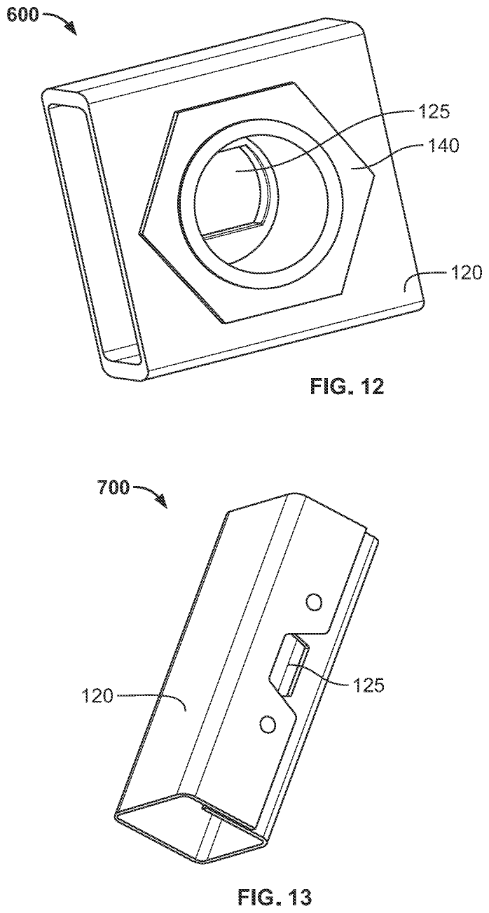

As shown in FIGS. 10-12, a hitch mounting system 600 may include a receiving member 140 that is secured directly to the frame 120. In these embodiments, the receiving member 140 may be welded directly to an aperture or opening in the frame 120. The frame 120 may include a portion with additional material provided for more support to help handle additional weights. This may include folded portions of the frame 120 used to form the aperture/opening. The receiving member 140 may be inserted into the aperture/opening and welded thereto. While welded is shown, the receiving member 140 may be attached such as through fastening, pinning or even a friction fit. As shown in FIG. 11, an insert 155 may be inserted into the opening/aperture and then the receiving member 140 attached thereto or the receiving member 140 may be integrally formed with the insert 155. The insert 155 and/or receiving member 140 may extend through the entirety of the frame 120 or only a portion thereof. The insert 155 and/or receiving member 140 are shown in FIG. 12 as extending entirely threrethrough.

In another embodiment, illustrated in FIG. 13, a hitch mounting system 700 may comprise the frame 120 may be formed to include at least one aperture 125 by overlapping flange portions of the frame 120 in which the aperture 125 is configured to receive a receiving member 140 or may be configured to directly accept an accessory mounting member, such as that for a leg of a fifth wheel hitch. In such embodiment, the aperture 125 could act as the receiving member 140 and would be monolithically formed with the frame 120. The aperture or slot 125 may be shaped to accommodate various designs. The frame 120 may be configured to accommodate the use of a t-pin style engagement system having a t-bushing. In this embodiment, installation of an accessory, including, without limitation, a fifth wheel or gooseneck hitch may be integrated in the truck bed and may not require the use of pin attachments from underneath the bed. In another embodiment, the hitch mounting system 700 may accommodate overlap joints for attachment of an additional bolt-on under bed system for the use of heavy-duty trucks.

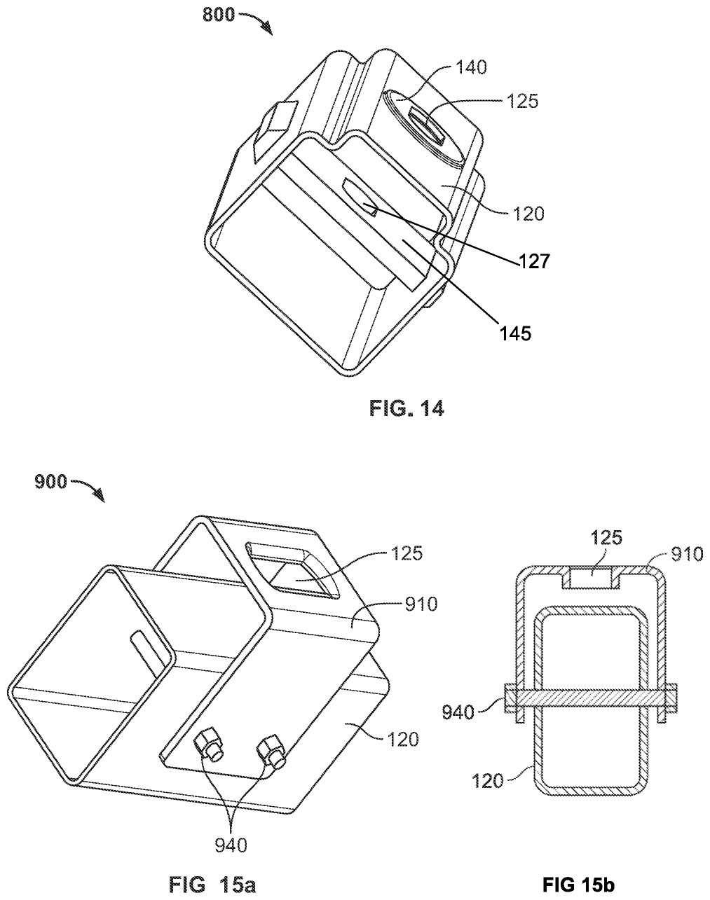

In an embodiment shown in FIG. 14, a hitch mounting system 800 may include the frame 120 with a saddle portion that may be integrally formed with the frame 120 such as through hydro-forming, stamping or the like. As shown, the saddle portion may be monolithically formed with the frame 120. The hitch mounting system 800 may include a receiving member 140 with an aperture 125. The receiving member 140 may be attached with the frame 120 in any appropriate manner, such as through welding, fastening, threading, or being integrally formed therewith. The hitch mounting system 800 may include an engagement/locking member 145 that extends into the frame 120 below the receiving member 140. The engagement/locking member 145 may include an aperture 127. The accessory may engage the aperture 127 to operatively lock such accessory to the hitch mounting system 800. The hitch mounting system 800 may be of a configuration to allow a longer pin member (such as a t-pin member) to be inserted through aperture 125 and into aperture 127 then rotated to secure the accessory to the hitch mounting system 800.

In another embodiment, a hitch mounting system 900 may further include mounting structures 910 such as brackets as shown in FIGS. 15a and 15b for example, along the top surface of the frame 120 by any fastening configuration including welding and/or bolting to present a saddle-shaped receiving member with slot/rail slot. FIGS. 15a and 15b illustrate the use of a bolt 940 or rivet fastening configuration that may be utilized on either the inboard, outboard, or a combination of both sides of a frame 120 to attach mounting structure 910 to the frame 120. The mounting structure 910 may include the receiving member 140 or other configuration. The receiving member 140 may include aperture 125 through which an accessory may be attached as described above. The mounting structure 910 may act as a saddle to position the receiving member 140 and aperture 125 in their operative position relative to the load bed 120. The position at which the bolts/rivets 940 are used to attach the mounting structure 910 to the frame 120 may be moved up or down relative to the frame 120 to accommodate the vehicle to which the hitch mounting system 900 is attached. In this case, the mounting structure 910 can be positioned along the height of the frame 120 then fixed thereto using the bolts/rivets 940 to position the receiving member 140 and aperture 125 generally evenly/parallel to the load bed 110.

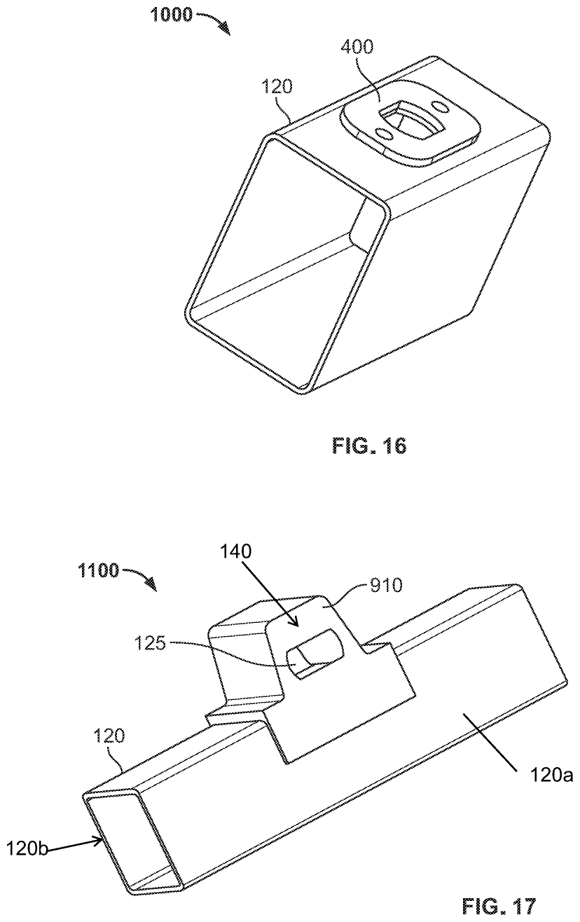

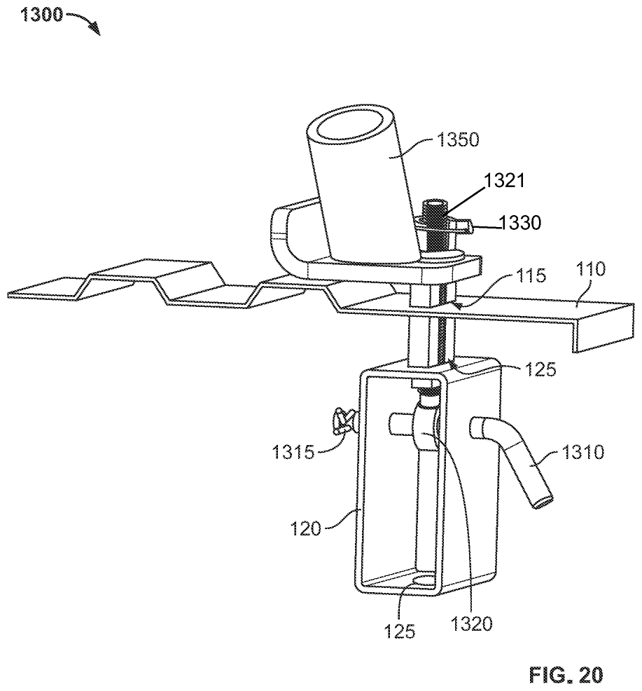

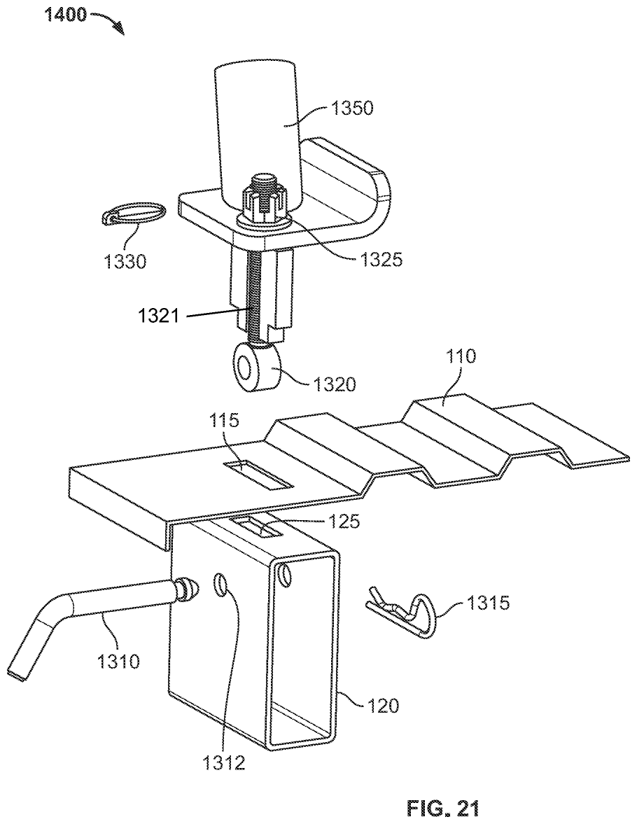

As shown in FIG. 16, a hitch mounting system 1000 may include a receiving member interface 400 affixed to the top of the frame 120 via any suitable configuration of fastening including, but not limited, to a fastener, a bolt configuration, rivets, welding or the like. The receiving member interface 400 may further include a slot or hole/aperture 125 for connection with an anti-rattle eyelet 1320 such as one used in the mounting system depicted in FIGS. 20 and 21, or any other suitable means of retention, including, without limitation the T-pin locking system disclosed in U.S. Pat. No. 7,121,573. The receiving member interface 400 may span a single or multiple layers of the frame 120 top surface. Moreover, additional supporting material may be added, such as through additional receiving member interface 400 with the aperture 125 to an underside of the frame 120. This may allow the hitch mounting system 1000 to handle additional loads.

As shown in FIG. 17, a hitch mounting system 1100 may include a mounting structure 910 with a receiving member 140 and aperture 125. In this embodiment, the mounting structure 910 is positioned and attached to the frame 120 on three sides, the left and right sides and the top side. It should be noted that in FIG. 17 surface 120a of the frame 120 is the “top” surface of the frame and faces the load bed 110 of the vehicle while opposing surface 120b is the “bottom” of the frame. In these embodiments, the mounting structure 910 may be positioned on either the left or right side of the frame 120 such that it extends in toward a center of the load bed 110 or away from the center of the load bed 110. Mounting structure 910 is mounted to the side of the frame 120. The mounting structure 910 may be on either side of frame 120 as long as aperture 125 aligns with an aperture 115 in the load bed 110 of the vehicle. The mounting structure 910 may be formed in any appropriate manner, including, without limitation, through casting or the like. The mounting structure 910 may be attached to the frame 120 such as by welding or fastening. The mounting structure 910 may include the receiving member 140 and aperture 125 and may operate as described otherwise in this disclosure.

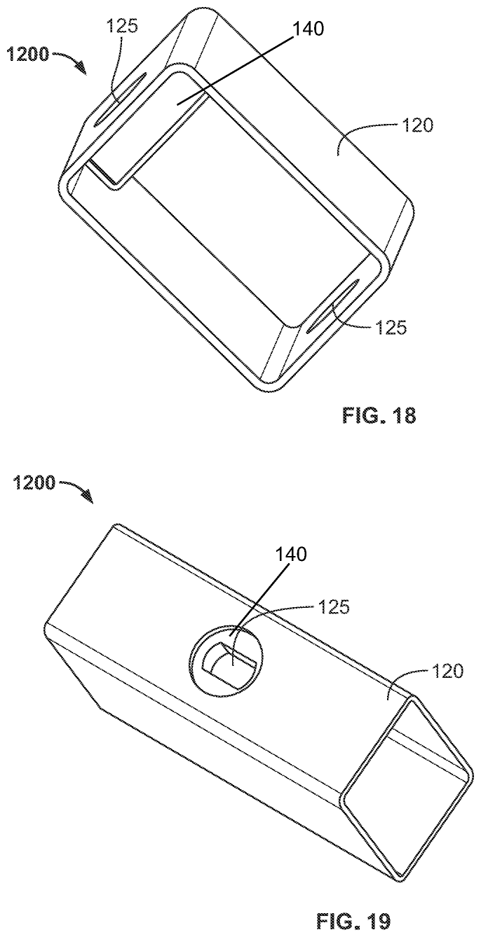

As shown in FIGS. 18 and 10, a hitch mounting system 1200 may include a receiving member 140 affixed to the top of the frame 120 via any suitable configuration of fastening including, but not limited, to a fastener, a bolt configuration, rivets, welding or the like. The receiving member 140 may further include a slot or hole/aperture 125 for connection any suitable means of retention, including, without limitation the T-pin locking system disclosed in U.S. Pat. No. 7,121,573. The receiving member 140 may span a single or multiple layers of the frame 120 top surface and as shown in FIG. 18 may be attached to an underside of the top of the frame 120. Moreover, the frame 120 may include aperture 125 to allow for insertion of an engagement device to lock an accessory to the hitch mounting system 1200 or to allow for drainage of water and debris from the frame 120 and the hitch mounting system 1200.

In another embodiment, as illustrated in FIGS. 20 and 21, a hitch mounting system 1300 may utilize an ISR (Industry Standard Rail) towing system. In this embodiment, both the bed 110 and the frame 120 or just the frame 120 may include apertures 1312 disposed between the frame 120 walls or to inside/outside frame wall(s). Further, an ISR-style foot 1350 may be configured for placement onto the bed 110 and into the frame 120. A pin 1310 may further slide through the apertures 1312 and through anti-rattle eyelet 1320 to lock to frame 120 with the ISR system. The retention pin 1310 may be retained in place by use of a clip 1315. The anti-rattle eyelet 1320 may have a threaded element 1321 attached thereto which allows for the anti-rattle eyelet 1320 to be adjusted to align with aperture 1312 in the frame 120. A locking crown bolt 1325 may be used along with locking ring 1330 to ensure that the anti-rattle eyelet 1320 does not move once placed in the proper alignment position to allow for retention pin 1310 to be secured in place with locking key 1315.

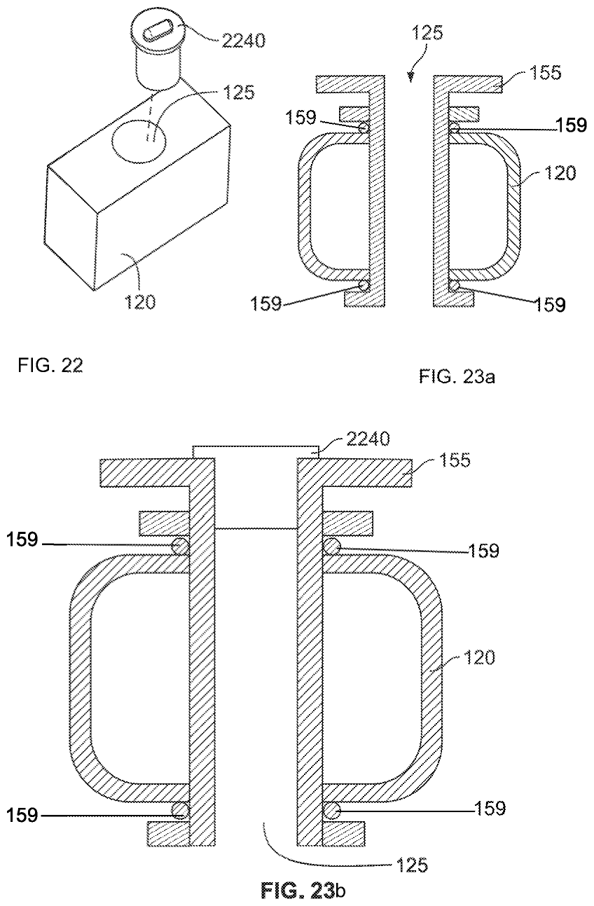

As illustrated in FIGS. 22 and 23, the interface between the frame 120 or insert 155 and a receiving member 140 may include a recess or aperture 125 to hold a removable nut or a plug 2240 inside the top of the frame 120 as well as being able to retain a receiving member 140 (not shown). FIGS. 22 and 23 show welds 159 attaching insert 155 to framer 120. The removably nut or plug 2240 may be attached with the frame 120 in any appropriate manner, including, without limitation by threading, fastening, via friction fit, bayonet locking system or the like. The removable nut or plug 2240 may comprise the receiving member 140. In this embodiment, the user may engage removable nut or plug 2240 with the frame 120 to use the hitch mounting system and may remove the removable nut or plug 2240 when not in use.

Shown in FIGS. 23a and 23b are cross-sectional views showing the insert 155 welded to the frame 120. What is shown could comprise any of the embodiments shown above where the insert is welded to the frame 120. The insert 155 may be inserted into frame aperture 125 and welded via welds 159 to the frame 120. This may secure the insert 155 with the frame 120. The receiving member 140 may be attached to the insert 155 in any appropriate manner or the insert 155 itself may act as the receiving member 140.

In a further embodiment illustrated in FIG. 24, frame apertures 125 may be formed in the frame 120 by cutting a portion of the frame 120 at 120a and 120b and folding the cut material in a way so as to form the frame aperture 125. The folds of frame material may vary and may be partially downward into the interior of the frame as shown in 120a or may be folded completely back on itself as in 120b which can result in a strengthening of the perimeter of the frame aperture 125. The folded apertures 120a and 120b may be used as shown in FIG. 24 or may be reversed or used in the same configuration (for example 120a on both top and bottom of the frame 120 or 120b on both top and bottom of the frame 120). In a further embodiment, the folds in the frame material may be towards the interior of the frame as shown for 120a or towards the external surface of the frame as shown for 120b.

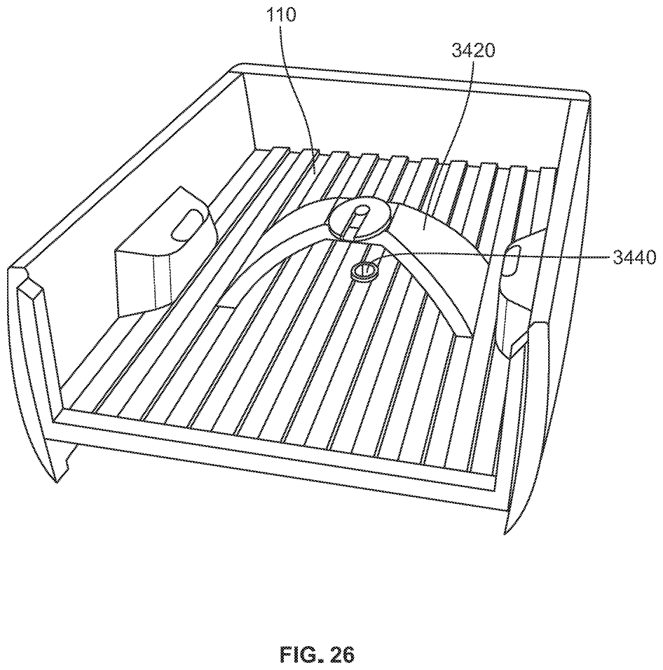

In another embodiment shown, in part, in FIGS. 25 and 26, the frame 120 may include one or more receiving members 140, with four being shown in FIG. 25 as well as a fifth receiving member for a hitch attachment such as a ball hitch or goose neck hitch where receiving members 140 can be used for security chain attachment. In addition, as shown in FIG. 26, the receiving members (as shown in FIG. 25) provide a threaded mounting stud 3340 for an attachment of an accessory, such as a fifth wheel hitch system 3420, and above bed rail (not shown) or a gooseneck adapter frame attachment 3320.

The system in all embodiments disclosed herein is configured to be loose enough to adapt to variations in frame design while maintaining integrity when an accessory, such as a fifth wheel or other attachment is installed so that the travel is controlled to provide firm attachment through the given clamp load. In addition, in all embodiments, the frame apertures 125 (and inserts 155 if present) in the frame 120 align with and are accessible through body apertures 115 in the body 110 (or bed) of the vehicle.

Further, for the sake of brevity in many of the descriptions above only described a single receiving member 140 of the applicable hitch mounting system. It should be understood, however, that any appropriate number of receiving members 140 may be utilized with the applicable hitch mounting system. Further, it should be understood that the various embodiments of the hitch mounting systems described herein may be used interchangeably. In those instances, each of the hitch mounting systems may be of a different configuration. For example, hitch mounting system 600 may be used at one spot on the frame 120, hitch mounting system 700 at a second spot on the frame 120, hitch mounting system 800 on a third spot on the frame 120 (such as lateral from the hitch mounting system 600) and hitch mounting system 900 on a fourth spot on the frame 120. Any combination of the embodiments of the hitch mounting systems described herein may be interchangeably used without departing from the present teachings.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. By way of non-limiting example, other accessories may be attached to the vehicle utilizing the under bed hitch mounting system, such as bike racks, ramps, storage containers, etc. The claims as follows are intended to include all modifications and alterations insofar as they come within the scope of the claims or the equivalent thereof.

1. A vehicle comprising a frame and a body, and further comprising a hitch or cargo carrying mounting system that is integrated into or onto the frame of the vehicle and is accessible through at least one aperture in the body of the vehicle.

2. The vehicle of claim 1, wherein the frame of the vehicle has at least one frame aperture for receiving a hitch or cargo carrying attachment and the body of the vehicle has at least one body aperture which matches up with the frame aperture.

3. The vehicle of claim 1, wherein the hitch mounting system comprises at least one mounting structure that is attached to the frame of the vehicle, and the body of the vehicle has at least one body aperture which matches up with the mounting structure attached to the frame.

4. The vehicle of claim 2 wherein there are at least five frame apertures and five corresponding body apertures.

5. The vehicle of claim 3, wherein there are at least 4 mounting structures attached to the frame of the vehicle and 4 corresponding body apertures.

6. The vehicle of claim 5, further comprising at least one aperture in the frame of the vehicle which matches up with at least one aperture in the body of the vehicle.

7. The vehicle of claim 2, wherein the frame aperture has at least one insert inside the aperture which is configured to receive a trailer hitch mechanism.

8. The vehicle of claim 2, wherein the hitch mounting system comprises
a receiving member attachment that is inserted in one or more of the apertures in the frame of the vehicle and passes through one or more of the corresponding holes in the body of the vehicle.

9. The vehicle of claim 8, wherein the receiving member attachment is configured to receive a fifth wheel-type trailer hitch.

10. The vehicle of claim 2, wherein the frame aperture has at least one insert that is incorporated inside the frame aperture wherein the insert is configured to receive a trailer hitch mechanism or cargo carrying attachment mechanism.

11. The vehicle of claim 10, wherein the insert is a threaded sleeve.

12. The vehicle of claim 3 wherein the mounting structure has at least one mounting structure aperture.

13. The vehicle of claim 12, wherein the mounting structure aperture has at least one insert incorporated inside the aperture wherein the insert has an insert aperture which is configured to receive a trailer hitch mechanism.

14. The vehicle of claim 13, wherein the insert in the mounting structure comprises a threaded sleeve and wherein the body aperture matches up with the threaded sleeve.

15. The vehicle of claim 3 wherein the mounting structure is attached to the frame by bolts, welds or a combination thereof.

16. The vehicle of claim 15, wherein the bolts go through the frame or are part of a clamp or bracket device that attaches around at least part of the frame.

17. The vehicle of claim 12 further comprising a receiving member inserted into the mounting structure aperture.

18. The vehicle of claim 13 further comprising a receiving member inserted into the insert aperture.

19. The vehicle of claim 10, wherein the insert has an internal insert aperture that extends entirely through the insert and the frame aperture extends entirely through the frame.

20. The vehicle of claim 13, wherein the insert in the mounting structure has an insert aperture that extends entirely through the insert and the mounting structure aperture extends entirely through the frame.

21. A mounting system for attaching a hitch mounting system or cargo carrying accessory to a frame of a vehicle having a body and a frame, the mounting system comprising at least one mounting structure that is capable of being attached to the frame of the vehicle, wherein the body of the vehicle has at least one body aperture which matches up with the mounting structure when attached to the frame.

22. The mounting system of claim 21, wherein the mounting structure has at least one mounting structure aperture.

23. The mounting system of claim 22, wherein the mounting structure aperture has at least one insert incorporated inside the aperture wherein the insert has an insert aperture that is configured to receive a hitch mounting system or cargo carrying accessory.

24. The mounting system of claim 23, wherein the insert in the mounting structure comprises a threaded sleeve and wherein the body aperture matches up with the threaded sleeve.

25. The mounting system of claim 21 wherein the mounting structure is attached to the frame of the vehicle by bolts, welds or a combination thereof.

26. The mounting system of claim 25, wherein the bolts go through the frame or are part of a clamp or bracket device that attaches around at least part of the frame.

27. The mounting system of claim 23 wherein the insert in the mounting structure has an insert aperture that extends entirely through the insert and the mounting structure aperture extends entirely through the mounting structure.

28. The mounting system of claim 22 further comprising a receiving member incorporated into the mounting system aperture.

29. The mounting system of claim 23 further comprising a receiving member incorporated into the insert aperture.
